(19) United States
(12) Patent Application Publication
(10) Pub. No.: US 2009/0139383 A1
(43) Pub. Date: Jun. 4, 2009

(54) Food Processor Cutting Device Having a Position Adjustment Function

(76) Inventor: Cheng-Yen Tsai, Tainan City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/946,990

(22) Filed: Nov. 29, 2007

(51) Int. Cl. B26D 1/01; B26D 1/45; B26D 7/00

(52) U.S. Cl. 83/490; 83/492; 83/497

(57) ABSTRACT

A cutting device for a food processor includes a base, a cutting unit mounted on the base, a plurality of position adjustment units connected with the cutting unit to adjust a position of the cutting unit, a transmission unit mounted on the base and connected with the cutting unit to drive the cutting unit, a push unit connected with the transmission unit to drive the transmission unit, and a driving unit connected with the push unit to drive the push unit. Thus, each of the position adjustment units presses the cutting unit to adjust the position of the cutting unit so as to tighten and locate the cutting unit, thereby preventing the cutting unit from being loosened or vibrated.

### BACKGROUND OF THE INVENTION

1. Field of the Invention

The present invention relates to a cutting device and, more particularly, to a cutting device for a food processor.

2. Description of the Related Art

A conventional cutting device for a food processor comprises a base having a central portion provided with a through hole to allow passage of a dough, a cutting unit mounted on the base and including a plurality of cutting blades that are movable to cross the through hole of the base to cut the dough, and a driving unit connected with the cutting unit to drive the cutting blades of the cutting unit. However, the cutting blades of the cutting unit become loosened easily during a long-term utilization, thereby greatly decreasing the working efficiency of the cutting unit.

### BRIEF SUMMARY OF THE INVENTION

In accordance with the present invention, there is provided a cutting device, comprising a base, a cutting unit mounted on the base, a plurality of position adjustment units connected with the cutting unit to adjust a position of the cutting unit, a transmission unit mounted on the base and connected with the cutting unit to drive the cutting unit, a push unit connected with the transmission unit to drive the transmission unit, and a driving unit connected with the push unit to drive the push unit.

The primary objective of the present invention is to provide a food processor cutting device having a position adjustment function.

Another objective of the present invention is to provide a cutting device, wherein the threaded rod of each of the position adjustment units is rotated to push the elastic member which pushes the pressing member to press the respective pivot shaft of the cutting unit to adjust the position of the respective cutting blade of the cutting unit so as to tighten and locate the cutting unit, thereby preventing the cutting unit from being loosened or vibrated.

A further objective of the present invention is to provide a cutting device, wherein the position adjustment units press the pivot shafts of the cutting unit to prevent a clearance from being formed between the cutting blades of the cutting unit, thereby enhancing the working efficiency and lifetime of the cutting unit.

A further objective of the present invention is to provide a cutting device, wherein the cutting blades of the cutting unit are movable simultaneously by connection between the driven posts of the cutting unit and the limit slots of the rotation disk of the transmission unit so that the cutting blades of the cutting unit are operated exactly and smoothly.

A further objective of the present invention is to provide a cutting device, wherein a user only needs to detach the propeller shaft of the push unit for maintenance of the cutting device without having to reset and test the driving unit, thereby facilitating maintenance of the cutting device.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a cutting device in accordance with the preferred embodiment of the present invention.

FIG. 2 is a partially exploded perspective view of the cutting device as shown in FIG. 1.

FIG. 3 is an exploded perspective view of the cutting device as shown in FIG. 1.

FIG. 4 is a partially exploded perspective view of the cutting device as shown in FIG. 1.

FIG. 5 is a front cross-sectional view of the cutting device as shown in FIG. 1.

FIG. 6 is a top view of the cutting device as shown in FIG. 1.

FIG. 7 is a schematic operational view of the cutting device as shown in FIG. 6.

FIG. 8 is a partially exploded perspective view of a cutting device in accordance with another preferred embodiment of the present invention.

FIG. 9 is a top assembly view of the cutting device as shown in FIG. 8.

FIG. 10 is a cross-sectional view of the cutting device taken along line 10-10 as shown in FIG. 9.

FIG. 11 is a partially exploded perspective view of a cutting device in accordance with another preferred embodiment of the present invention.

### DETAILED DESCRIPTION OF THE INVENTION

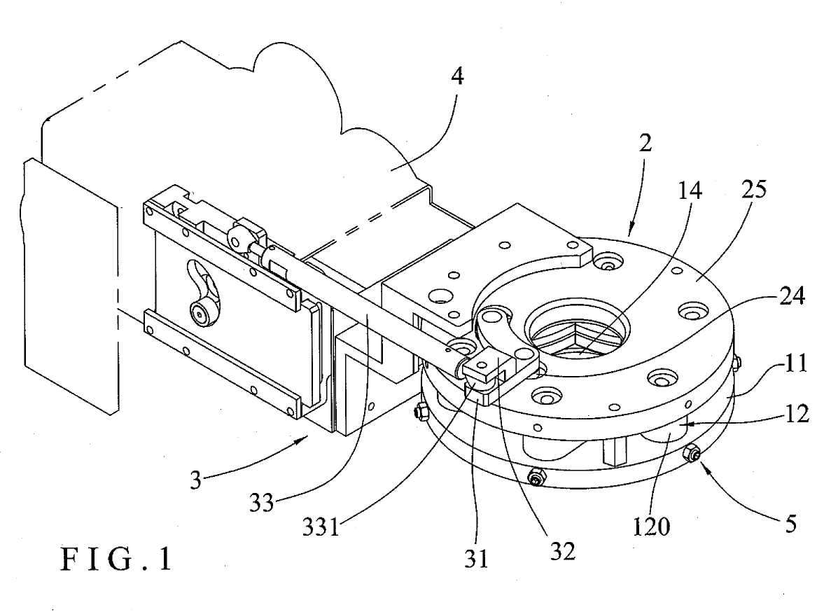

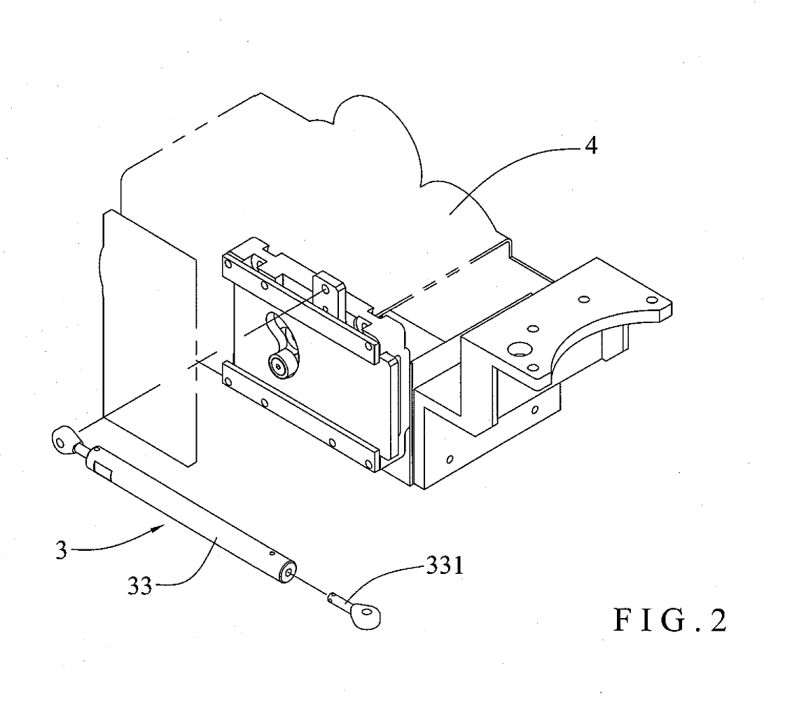

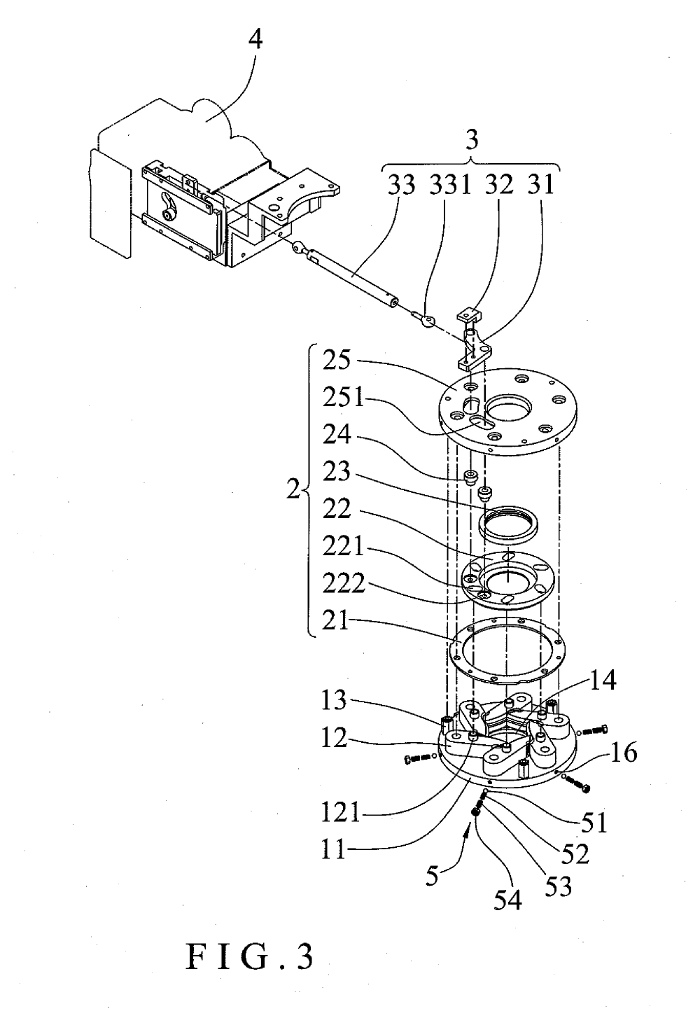

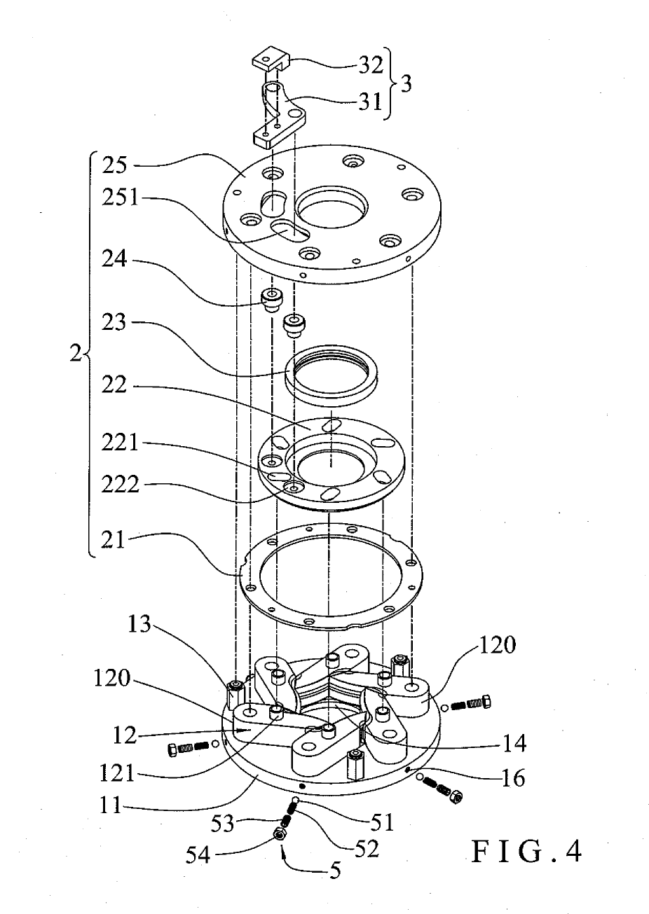

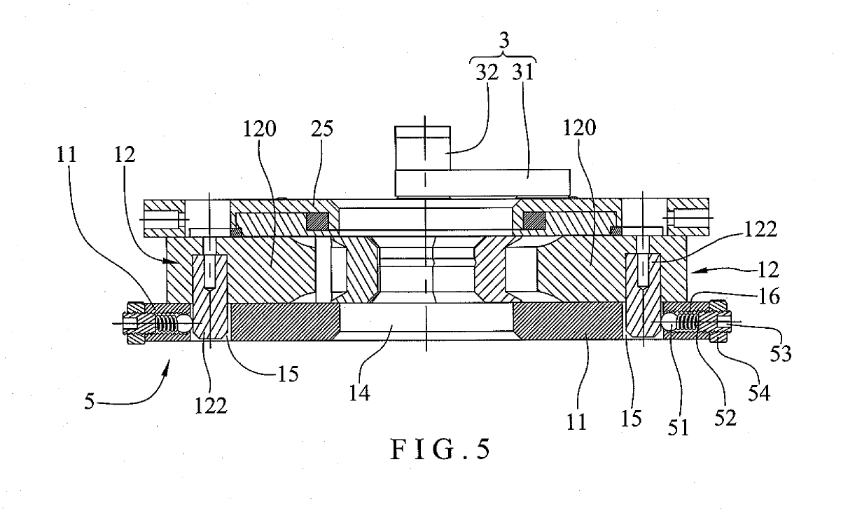

Referring to the drawings and initially to FIGS. 1-7, a cutting device for a food processor in accordance with the preferred embodiment of the present invention comprises a base 11, a cutting unit 12 mounted on the base 11, a plurality of position adjustment units 5 connected with the cutting unit 12 to adjust a position and tension of the cutting unit 12, a transmission unit 2 mounted on the base 11 and connected with the cutting unit 12 to drive the cutting unit 12, a push unit 3 connected with the transmission unit 2 to drive the transmission unit 2, and a driving unit 4 connected with the push unit 3 to drive the push unit 3.

The base 11 has a central portion provided with a through hole 14 to allow passage of dough (not shown). The base 11 has a surface provided with a plurality of pivot holes 15 surrounding the through hole 14 and a peripheral wall provided with a plurality of screw bores 16 each connected to a respective one of the pivot holes 15. The base 11 is provided with a plurality of upright fixing posts 13.

The transmission unit 2 includes an annular fixed cover 25 mounted on the base 11, an annular rotation disk 22 rotatably mounted between the fixed cover 25 and the base 11, at least one driven member 24 movably mounted between the fixed cover 25 and the base 11 and secured to the rotation disk 22 to rotate the rotation disk 22, a ring-shaped bearing 23 mounted between the fixed cover 25 and the rotation disk 22 to facilitate rotation of the rotation disk 22, and an annular limit plate 21 mounted between the fixed cover 25 and the base 11 and surrounding the rotation disk 22 to limit the rotation disk 22. The rotation disk 22 of the transmission unit 2 has a surface provided with a plurality of elongate limit slots 221 and at least one fixing hole 222. The at least one driven member 24 of the transmission unit 2 is fixed in the at least one fixing hole 222 of the rotation disk 22. The fixed cover 25 of the transmission unit 2 is supported by the fixing posts 13 of the base 11 and has a surface provided with at least one elongate guide slot 251 in which the at least one driven member 24 of the transmission unit 2 is slidable.

The push unit 3 includes a substantially V-shaped driving member 31 movably mounted on the fixed cover 25 and having a first end secured to the at least one driven member 24 of the transmission unit 2 to move the at least one driven member 24 of the transmission unit 2, a connector 331 having a first end pivotally mounted on a second end of the driving member 31, a propeller shaft 33 having a first end secured to a second end of the connector 331 to push the driving member 31 by the connector 331 and a second end connected to and driven by the driving unit 4, and a retaining member 32 mounted on the driving member 31 and abutting the connector 331 to retain the connector 331 on the driving member 31. The connector 331 of the push unit 3 is pivotally mounted in the retaining member 32.

The driving unit 4 includes a motor (not shown) connected with the propeller shaft 33 of the push unit 3 to drive and move the propeller shaft 33 of the push unit 3 reciprocally.

The cutting unit 12 includes a plurality of pivot shafts 122, a plurality of cutting blades 120 each pivotally mounted between the base 11 and the transmission unit 2 and each having a first end mounted on a respective one of the pivot shafts 122 and a second end movable to cross the through hole 14 of the base 11, and a plurality of driven posts 121 each secured on a mediate portion of a respective one of the cutting blades 120 to drive the respective cutting blade 120 to pivot about the respective pivot shaft 122 and each mounted in and driven by a respective one of the limit slots 221 of the rotation disk 22 of the transmission unit 2. Each of the driven posts 121 of the cutting unit 12 is located between the respective pivot shaft 122 and the second end of the respective cutting blade 120 and is slidable in the respective limit slot 221 of the rotation disk 22 of the transmission unit 2. Each of the pivot shafts 122 has a first end pivotally mounted in a respective one of the pivot holes 15 of the base 11 and a second end protruding outwardly from the base 11 and inserted into the first end of the respective cutting blade 120. Preferably, each of the pivot holes 15 of the base 11 has an elongate shape to allow movement of the respective pivot shaft 122 of the cutting unit 12 so as to adjust the tension between the cutting blades 120 of the cutting unit 12.

Each of the position adjustment units 5 is mounted on the base 11 and includes a pressing member 51 movably mounted in a respective one of the screw bores 16 of the base 11 and movable to press a respective one of the pivot shafts 122 of the cutting unit 12 to adjust a position of a respective one of the cutting blades 120 of the cutting unit 12, a threaded rod 53 having a first end screwed into a respective one of the screw bores 16 of the base 11 and a second end protruding outwardly from the base 11, an elastic member 52 mounted in a respective one of the screw bores 16 of the base 11 and biased between the pressing member 51 and the threaded rod 53 to push the pressing member 51 toward the respective pivot shaft 122 of the cutting unit 12, and a locking nut 54 screwed onto the second end of the threaded rod 53 and resting on the peripheral wall of the base 11 to lock the threaded rod 53 onto the base 11.

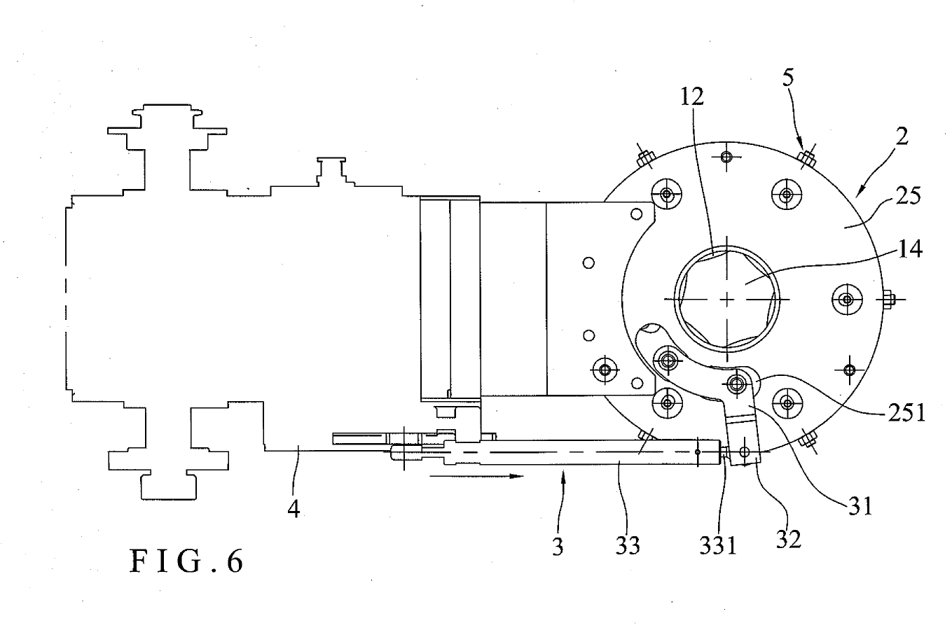

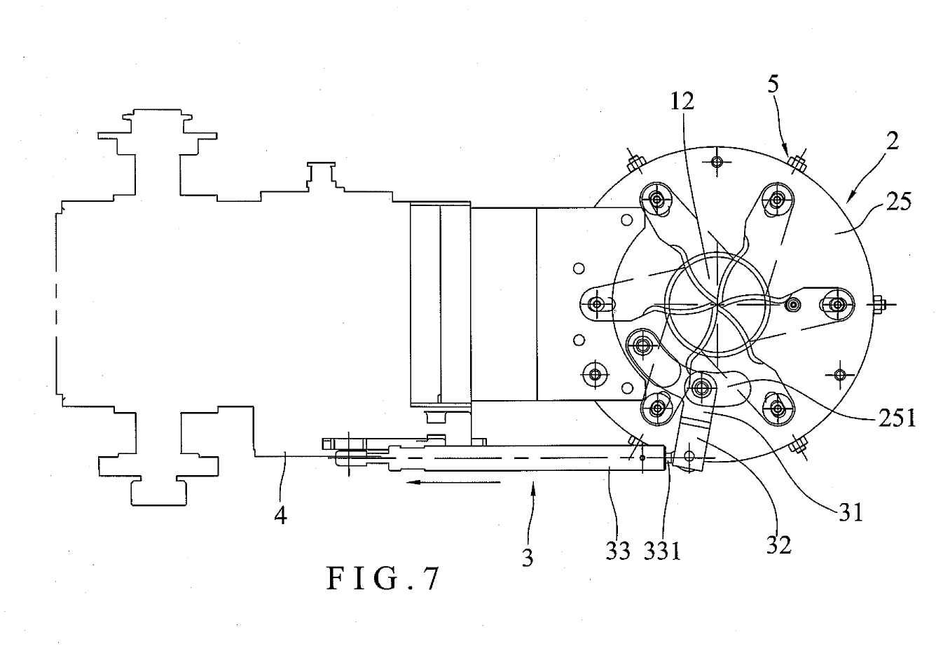

In operation, referring to FIGS. 6 and 7 with reference to FIGS. 1-5, the driving unit 4 drives the propeller shaft 33 of the push unit 3 reciprocally so that the propeller shaft 33 of the push unit 3 is movable forward and backward to drive the connector 331 which drives and pivot the driving member 31 which drives and moves the at least one driven member 24 which drives and rotates the rotation disk 22 which drives and moves the driven posts 121 which drive and pivot the cutting blades 120 about the pivot shafts 122. In such a manner, the cutting blades 120 are movable between a first position as shown in FIGS. 1 and 6 where the cutting blades 120 are spaced from the through hole 114 of the base 11 to form an open state to allow passage of the dough and a second position as shown in FIG. 7 where the cutting blades 120 extend into the through hole 14 of the base 11 to form a closed state to cut the dough.

Accordingly, the threaded rod 53 of each of the position adjustment units 5 is rotated to push the elastic member 52 which pushes the pressing member 51 to press the respective pivot shaft 122 of the cutting unit 12 to adjust the position of the respective cutting blade 120 of the cutting unit 12 so as to tighten and locate the cutting unit 12, thereby preventing the cutting unit 12 from being loosened or vibrated. In addition, the position adjustment units 5 press the pivot shafts 122 of the cutting unit 12 to prevent a clearance from being formed between the cutting blades 120 of the cutting unit 12, thereby enhancing the working efficiency and lifetime of the cutting unit 12. Further, the cutting blades 120 of the cutting unit 12 are movable simultaneously by connection between the driven posts 121 of the cutting unit 12 and the limit slots 221 of the rotation disk 22 of the transmission unit 2 so that the cutting blades 120 of the cutting unit 12 are operated exactly and smoothly. Further, a user only needs to detach the propeller shaft 33 of the push unit 3 for maintenance of the cutting device without having to reset and test the driving unit 4, thereby facilitating maintenance of the cutting device.

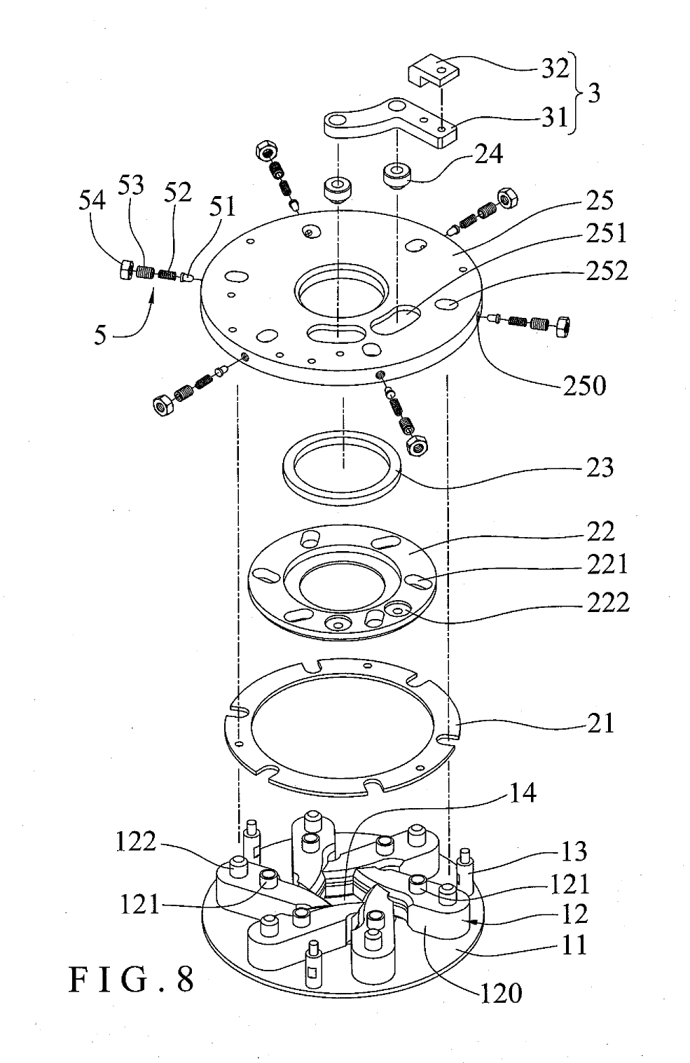

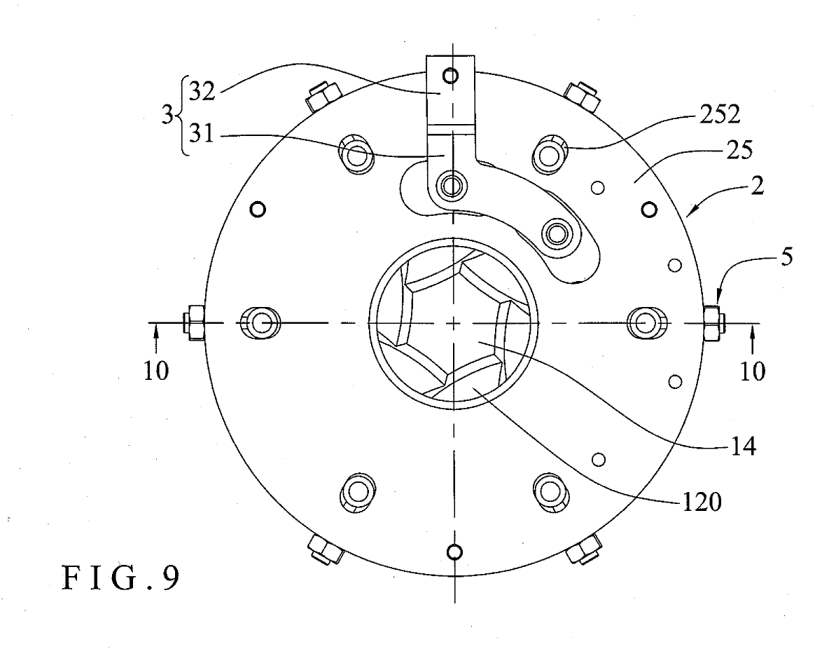

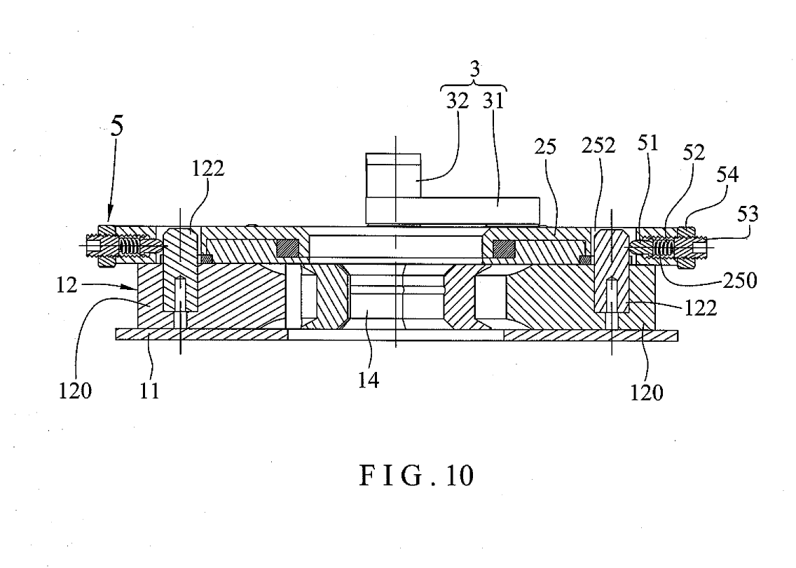

Referring to FIGS. 8-10, the fixed cover 25 of the transmission unit 2 has a surface provided with a plurality of pivot holes 252 and a peripheral wall provided with a plurality of screw bores 250 each connected to a respective one of the pivot holes 252. Each of the pivot shafts 122 has a first end pivotally mounted in a respective one of the pivot holes 252 of the fixed cover 25 and a second end protruding outwardly from the fixed cover 25 and inserted into the first end of the respective cutting blade 120. Preferably, each of the pivot holes 252 of the fixed cover 25 has an elongate shape to allow movement of the respective pivot shaft 122 of the cutting unit 12 so as to adjust the tension between the cutting blades 120 of the cutting unit 12. Each of the position adjustment units 5 is mounted on the fixed cover 25 of the transmission unit 2 and includes a pressing member 51 movably mounted in a respective one of the screw bores 250 of the fixed cover 25 and movable to press a respective one of the pivot shafts 122 of the cutting unit 12 to adjust a position of a respective one of the cutting blades 120 of the cutting unit 12, a threaded rod 53 having a first end screwed into a respective one of the screw bores 250 of the fixed cover 25 and a second end protruding outwardly from the fixed cover 25 of the transmission unit 2, an elastic member 52 mounted in a respective one of the screw bores 250 of the fixed cover 25 biased between the pressing member 51 and the threaded rod 53 to push the pressing member 51 toward the respective pivot shaft 122 of the cutting unit 12, and a locking nut 54 screwed onto the second end of the threaded rod 53 and resting on the peripheral wall of the fixed cover 25 to lock the threaded rod 53 onto the fixed cover 25.

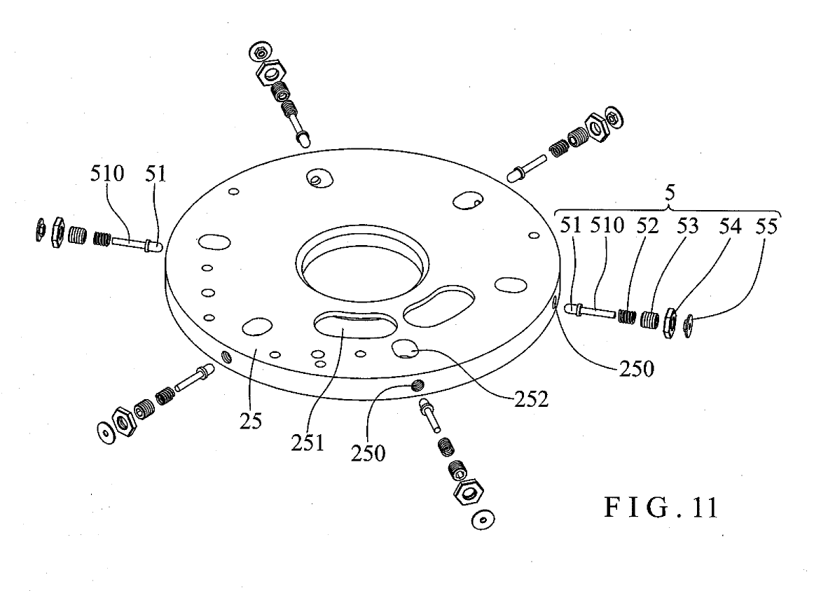

Referring to FIG. 11, the pressing member 51 of each of the position adjustment units 5 is provided with an elongate rod 510 extending through the elastic member 52 and the threaded rod 53 to increase the adjustment extent of each of the position adjustment units 5, and each of the position adjustment units 5 further includes a tap 55 inserted into the locking nut 54 to seal the threaded rod 53.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A cutting device, comprising:
a base;
a cutting unit mounted on the base;
a plurality of position adjustment units connected with the cutting unit to adjust a position of the cutting unit;
a transmission unit mounted on the base and connected with the cutting unit to drive the cutting unit;
a push unit connected with the transmission unit to drive the transmission unit;
a driving unit connected with the push unit to drive the push unit.

2. The cutting device in accordance with claim 1, wherein the transmission unit includes
an annular fixed cover mounted on the base;
an annular rotation disk rotatably mounted between the fixed cover and the base;
at least one driven member movably mounted between the fixed cover and the base and secured to the rotation disk to rotate the rotation disk.

3. The cutting device in accordance with claim 2, wherein the transmission unit further includes
a ring-shaped bearing mounted between the fixed cover and the rotation disk to facilitate rotation of the rotation disk;
an annular limit plate mounted between the fixed cover and the base and surrounding the rotation disk to limit the rotation disk.

4. The cutting device in accordance with claim 2, wherein
the rotation disk of the transmission unit has a surface provided with at least one fixing hole;
the at least one driven member of the transmission unit is fixed in the at least one fixing hole of the rotation disk.

5. The cutting device in accordance with claim 2, wherein the fixed cover of the transmission unit has a surface provided with at least one elongate guide slot in which the at least one driven member of the transmission unit is slidable.

6. The cutting device in accordance with claim 2, wherein the push unit includes
a driving member movably mounted on the fixed cover and having a first end secured to the at least one driven member of the transmission unit to move the at least one driven member of the transmission unit;
a connector having a first end pivotally mounted on a second end of the driving member;
a propeller shaft having a first end secured to a second end of the connector to push the driving member by the connector and a second end connected to and driven by the driving unit.

7. The cutting device in accordance with claim 6, wherein the push unit further includes
a retaining member mounted on the driving member and abutting the connector to retain the connector on the driving member.

8. The cutting device in accordance with claim 7, wherein the connector of the push unit is pivotally mounted in the retaining member.

9. The cutting device in accordance with claim 2, wherein
the base has a central portion provided with a through hole;
the rotation disk of the transmission unit has a surface provided with a plurality of elongate limit slots;
the cutting unit includes
a plurality of pivot shafts;
a plurality of cutting blades each pivotally mounted between the base and the transmission unit and each having a first end mounted on a respective one of the pivot shafts and a second end movable to cross the through hole of the base;
a plurality of driven posts each secured on a mediate portion of a respective one of the cutting blades to drive the respective cutting blade to pivot about the respective pivot shaft and each mounted in and driven by a respective one of the limit slots of the rotation disk of the transmission unit.

10. The cutting device in accordance with claim 9, wherein
the base has a surface provided with a plurality of pivot holes;
each of the pivot shafts has a first end pivotally mounted in a respective one of the pivot holes of the base and a second end protruding outwardly from the base and inserted into the first end of the respective cutting blade.

11. The cutting device in accordance with claim 10, wherein
the base has a peripheral wall provided with a plurality of screw bores each connected to a respective one of the pivot holes;
each of the position adjustment units is mounted on the base and includes
a pressing member movably mounted in a respective one of the screw bores of the base and movable to press a respective one of the pivot shafts of the cutting unit to adjust a position of a respective one of the cutting blades of the cutting unit;
a threaded rod having a first end screwed into a respective one of the screw bores of the base and a second end protruding outwardly from the base;
an elastic member mounted in a respective one of the screw bores of the base and biased between the pressing member and the threaded rod to push the pressing member toward the respective pivot shaft of the cutting unit;
a locking nut screwed onto the second end of the threaded rod and resting on the peripheral wall of the base to lock the threaded rod onto the base.

12. The cutting device in accordance with claim 9, wherein
the fixed cover of the transmission unit has a surface provided with a plurality of pivot holes;
each of the pivot shafts has a first end pivotally mounted in a respective one of the pivot holes of the fixed cover and a second end protruding outwardly from the fixed cover and inserted into the first end of the respective cutting blade.

13. The cutting device in accordance with claim 12, wherein each of the pivot holes of the fixed cover has an elongate shape to allow movement of the respective pivot shaft of the cutting unit so as to adjust a tension between the cutting blades of the cutting unit.

14. The cutting device in accordance with claim 12, wherein
the fixed cover of the transmission unit has a peripheral wall provided with a plurality of screw bores each connected to a respective one of the pivot holes;
each of the position adjustment units is mounted on the fixed cover of the transmission unit and includes
a pressing member movably mounted in a respective one of the screw bores of the fixed cover and movable to press a respective one of the pivot shafts of the cutting unit to adjust a position of a respective one of the cutting blades of the cutting unit;
a threaded rod having a first end screwed into a respective one of the screw bores of the fixed cover and a second end protruding outwardly from the fixed cover of the transmission unit;
an elastic member mounted in a respective one of the screw bores of the fixed cover biased between the pressing member and the threaded rod to push the pressing member toward the respective pivot shaft of the cutting unit;
a locking nut screwed onto the second end of the threaded rod and resting on the peripheral wall of the fixed cover to lock the threaded rod onto the fixed cover.

15. The cutting device in accordance with claim 14, wherein the pressing member of each of the position adjustment units is provided with an elongate rod extending through the elastic member and the threaded rod.

16. The cutting device in accordance with claim 14, wherein each of the position adjustment units further includes a tap inserted into the locking nut to seal the threaded rod.

17. The cutting device in accordance with claim 9, wherein each of the driven posts of the cutting unit is located between the respective pivot shaft and the second end of the respective cutting blade and is slidable in the respective limit slot of the rotation disk of the transmission unit.

18. The cutting device in accordance with claim 10, wherein each of the pivot holes of the base has an elongate shape to allow movement of the respective pivot shaft of the cutting unit.

19. The cutting device in accordance with claim 6, wherein the driving member of the push unit is substantially V-shaped.

20. The cutting device in accordance with claim 2, wherein
the base is provided with a plurality of upright fixing posts.
the fixed cover of the transmission unit is supported by the fixing posts of the base.
